(19) United States
(12) Patent Application Publication
(10) Pub. No.: US 2025/0180467 A1
(43) Pub. Date: Jun. 5, 2025

(54) High-throughput single-molecule photoacoustic absorption spectroscopy with nanomechanical oscillators

(71) Applicant: The Board of Trustees of the Leland Stanford Junior University, Stanford, CA (US)

(72) Inventors: Amir H. Safavi-Naeini, Stanford, VA (US); Kaveh Pezeshki, Stanford, CA (US); Wentao Jiang, Sunnyvale, CA (US)

(21) Appl. No.: 18/965,736

(22) Filed: Dec. 2, 2024

Related U.S. Application Data
(60) Provisional application No. 63/604,728, filed on Nov. 30, 2023.

(51) Int. Cl. G01N 21/17; G01N 21/31

(52) U.S. Cl. CPC G01N 21/1702; G01N 21/3103; G01N 2021/3125

(57) ABSTRACT

Optical spectroscopy based on adsorption of a sample on a surface of a mechanical resonator is provided. The sample is illuminated with light that is intensity modulated at or near the resonance frequency of a mode of the mechanical resonator. Thermal expansion caused by optical absorption at the sample effectively generates a force on the mechanical resonator that excites the resonant mode of the resonator. Thus a measurement of displacement or the like of the mechanical resonator (e.g., via the piezoelectric effect) provides the desired spectroscopic signal. Spectra can be obtained by sweeping a wavelength of the optical source or by using an optical dual-comb source having multiple emission wavelengths each intensity modulated at a different frequency.

### CROSS REFERENCE TO RELATED APPLICATIONS

This application claims priority from U.S. Provisional Patent Application 63/604,728 filed Nov. 30, 2023, which is incorporated herein by reference.

### GOVERNMENT SPONSORSHIP

This invention was made with Government support under contract N00014-20-1-2422 awarded by the Office of Naval Research, under contract 1941826 awarded by the National Science Foundation, under contract DE-AC02-76SF00515 awarded by the Department of Energy, and under contract FA9550-17-1-0002 awarded by the Air Force Office of Scientific Research. The Government has certain rights in the invention.

### FIELD OF THE INVENTION

This invention relates to optical absorption spectroscopy.

### BACKGROUND

As technology evolves, performing optical spectroscopy on ever-smaller samples is of interest, up to and including single-molecule spectroscopy. One path that research has taken to enable such spectroscopy is the use of mechanical resonators to enhance a spectroscopic signal. One such approach that has been demonstrated is based on a frequency shift of a resonant mode due to optical absorption at an adsorbed molecule. Here thermal expansion from the optical absorption causes the resonator properties to change, thereby leading to a measurable frequency shift. However, this approach will not work at cryogenic temperatures because of the vanishing thermal frequency shift coefficient of most materials at cryogenic temperatures, while it is often desired to perform spectroscopy at cryogenic temperatures. Accordingly, it would be an advance in the art to provide single-molecule spectroscopy with an approach that is compatible with cryogenic operation.

### SUMMARY

We consider performing spectroscopy on single molecules by measuring forces induced by absorption of electromagnetic radiation. Such a system would provide an approach to identify molecules, e.g. proteins, in a rapid and high-throughput manner by generating high-dimensional data pertaining to their absorption spectrum. In contrast to previous work, this approach is expected to be sufficiently sensitive to detect these forces at the single molecule level and sufficiently scalable to be operable with high throughput by performing many detections in parallel.

At first, the molecule or molecules of interest are deposited on the surface of the mechanical resonator. These resonators can have natural frequencies ranging from tens of MHz to a few GHz. The samples are then illuminated by light. The intensity of this light I(t) is modulated at a frequency at or close to the mechanical resonance frequency. A force F(t) at the modulation frequency is generated, which then drives the motion of the nanomechanical resonator through thermal expansion. This motion is read out from the resonator, e.g., via the piezoelectric effect using electrodes. The magnitude of the force will be proportional to the absorption coefficient of the molecule at the radiation frequency. By either sweeping the laser frequency or illuminating with a frequency comb of light beams, the absorption spectrum of the molecule can be determined from the piezoelectric voltage.

Prior work has demonstrated single-molecule spectroscopy with photothermal nanomechanics. In these schemes, the steady-state heating of an absorbing molecule heats the resonator, leading to a change in mechanical properties and therefore a shift of the resonance frequency. Our approach is significantly different: the optical field is periodically modulated, so the resulting periodic heating of the resonator directly drives the resonator mode via a force. Spectroscopy is therefore accomplished through coherent sensing of force, rather than an incoherent measurement of the natural frequency. A major advantage of force sensing as opposed to frequency sensing is that significant improvements of SNR in force sensing are possible by going to cryogenic temperatures.

Photothermal nanomechanics on the other hand does not function at low temperatures due to the vanishing thermal frequency shift coefficient of most materials. In contrast to established photoacoustic spectroscopy techniques there are important distinctions in the present work arising from the fact that we are using single and arrays of nanomechanical oscillators as our force sensors.

Compared to prior work on photothermal nanomechanical detectors, our approach has significant advantages:

1) We are increasing the signal-to-noise ratio by many orders of magnitude by using nanomechanical oscillators with extremely high force sensitivity. Our approach will be able to achieve single-molecule levels of sensitivity to enable single-molecule spectroscopy.

2) We have the ability to scale up to large numbers of devices for increased throughput without commensurate increases in complexity, especially on the optical subsystems.

3) We have the ability to combine with mass-sensing capabilities of these nanomechanical oscillators achieved by detecting frequency shifts on individual elements due to physisorption; together these will provide significantly improved identification of single molecules and proteins.

4) We will be able to operate at cryogenic temperatures to increase sensitivity, and further improve sensitivity by integration of quantum sensing capabilities, e.g., by coupling to superconducting microwave circuits to generate nonclassical states of motion (e.g., squeezed vacuum states) and perform quantum-enhanced detection.

5) Incoherent systems require averaging to minimize white noise, where N samples reduce noise by a factor of 1/\sqrt{N}. In contrast, noise in coherent systems can be reduced through band-pass filtering of the measurement signal around the driving frequency. Here, noise will scale linearly with the filter bandwidth, and therefore as 1/N. This is a factor of \sqrt{N} better than the incoherent case.

6) As the system is linear, many parallel measurements can be mapped to different regions of frequency space in the same sensor, and read out individually and simultaneously via heterodyne measurement.

7) Coherent systems are intrinsically compatible with quantum sensing schemes, which rely on phase-coherent manipulation of the ground state of the sensing system.

We envision that this system may be operated at both room temperature and cryogenic temperatures. At cryogenic temperatures (below 4 K), we expect a significant reduction in the thermal noise of the mechanical system as well as an increase in the responsivity due to increases in mechanical quality factor. Many other optimizations are possible at cryogenic temperatures. For example, the use of superconducting electrode materials would further reduce dissipation, increasing the quality factor. As nanomechanical resonators can be operated at single-phonon levels, quantum measurement techniques, e.g. squeezing, could enhance the sensitivity to below the standard quantum limit. This approach is also inherently scalable.

Commercial applications include, but are not limited to characterization systems, e.g., for proteomics.

### BRIEF DESCRIPTION OF THE DRAWINGS

FIGS. 1A-B schematically show operation of an embodiment of the invention.

FIG. 2 shows a first exemplary embodiment of the invention.

FIG. 3 shows a second exemplary embodiment of the invention.

FIG. 4 shows a third exemplary embodiment of the invention.

FIG. 5 shows a fourth exemplary embodiment of the invention.

FIG. 6 shows a fifth exemplary embodiment of the invention.

FIG. 7 shows a sixth exemplary embodiment of the invention.

FIGS. 8A-B show the resonator and its drum mode for exemplary calculations.

FIG. 9 schematically shows a simplified 1-D model for surface absorption exciting a mechanical oscillation.

FIG. 10A shows several regions on the top surface of the resonator having different calculated coupling of surface excitation to the resonant drum mode.

FIG. 10B shows the drum mode for the calculations of FIG. 10A.

FIG. 10C shows confinement of temperature rise largely to the top part of the resonator.

FIGS. 11A-E show several exemplary resonator modes.

FIG. 12 shows calculated single-molecule detection threshold vs. integration time at several temperatures.

### DETAILED DESCRIPTION

We consider an approach to perform spectroscopy on single molecules by measuring forces induced by absorption of electromagnetic radiation. Such a system would provide an approach to identify molecules, e.g. proteins, in a rapid and high-throughput manner by generating high-dimensional data pertaining to their absorption spectrum. In contrast to previous work, we consider a system that is sufficiently sensitive to detect these forces at the single molecule level and is sufficiently scalable to be operable with high throughput by performing many detections in parallel.

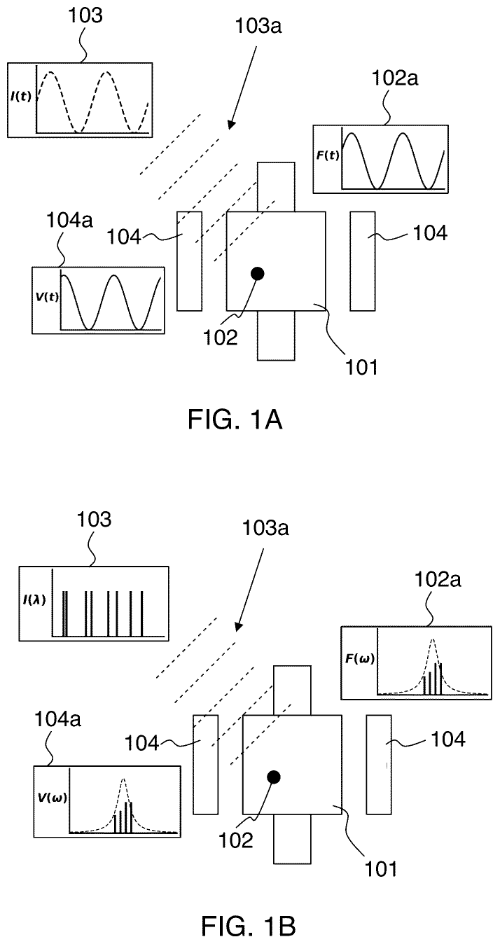

An outline of a single detector or “pixel” in this system is shown on FIG. 1A (time-domain) and FIG. 1B (schematic spectral view). At first, the molecule or molecules of interest 102 are deposited on the surface of the mechanical resonator 101. These resonators can have natural frequencies ranging from tens of MHz to a few GHz. The samples are then illuminated by light 103a from light source 103 at optical frequency ω_{L} (typically in the infrared). The intensity of this light I(t) is modulated at a frequency close to the mechanical resonance frequency (as schematically shown in 103). A force F(t) at the modulation frequency f_{mod} is generated (as schematically shown on 102a), which then drives the motion of the nanomechanical resonator near a resonant mode through thermal expansion. This motion is read out from the resonator via the piezoelectric effect using electrodes 104. The magnitude of the force will be proportional to the absorption coefficient of the molecule at the radiation frequency dr. By either sweeping the laser frequency @ or illuminating with a frequency comb of light beams, the absorption spectrum of the molecule can be determined from the voltage V (t) (schematically shown on 104a).

We envision that this system may be operated at both room temperature and cryogenic temperatures. At cryogenic temperatures (below 4 K), we expect a significant reduction in the thermal noise of the mechanical system as well as an increase in the responsivity due to increases in mechanical quality factor. Many other optimizations are possible at cryogenic temperatures. For example, the use of superconducting electrode materials would further reduce dissipation, increasing the quality factor. As nanomechanical resonators can be operated at single-phonon levels, quantum measurement techniques, e.g. squeezing, could enhance the sensitivity to below the standard quantum limit.

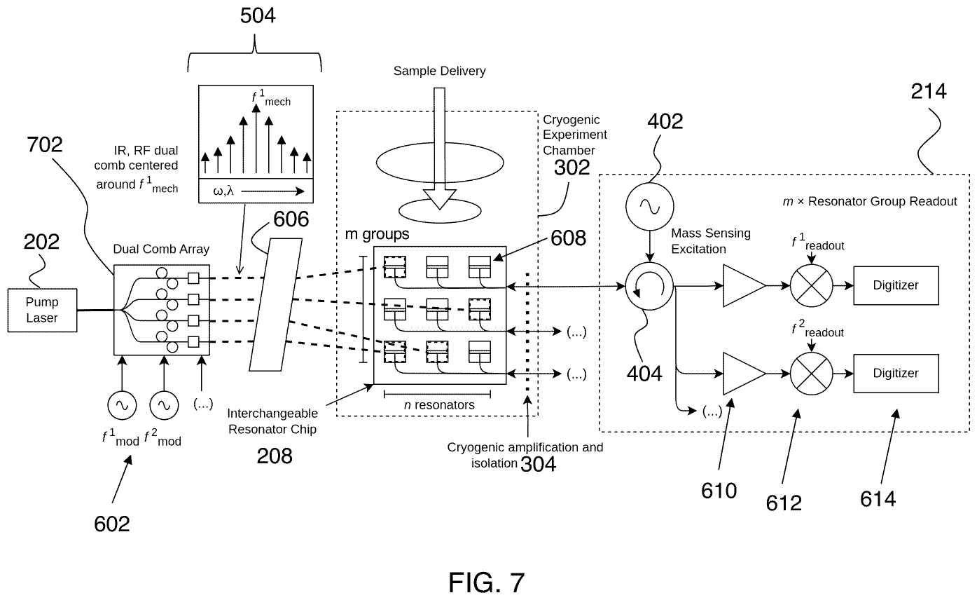

This system is also inherently scalable. One possible approaches for operating an array of such detectors to enable high-throughput sensing of a large number of molecules is shown below on FIG. 7. To better appreciate this relatively complex example, several simpler exemplary embodiments are considered first.

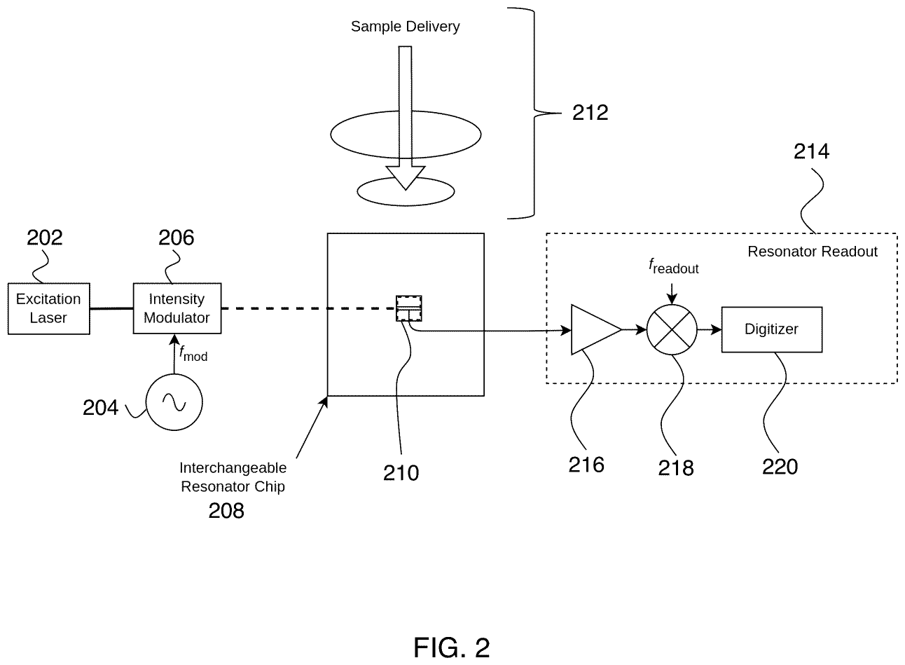

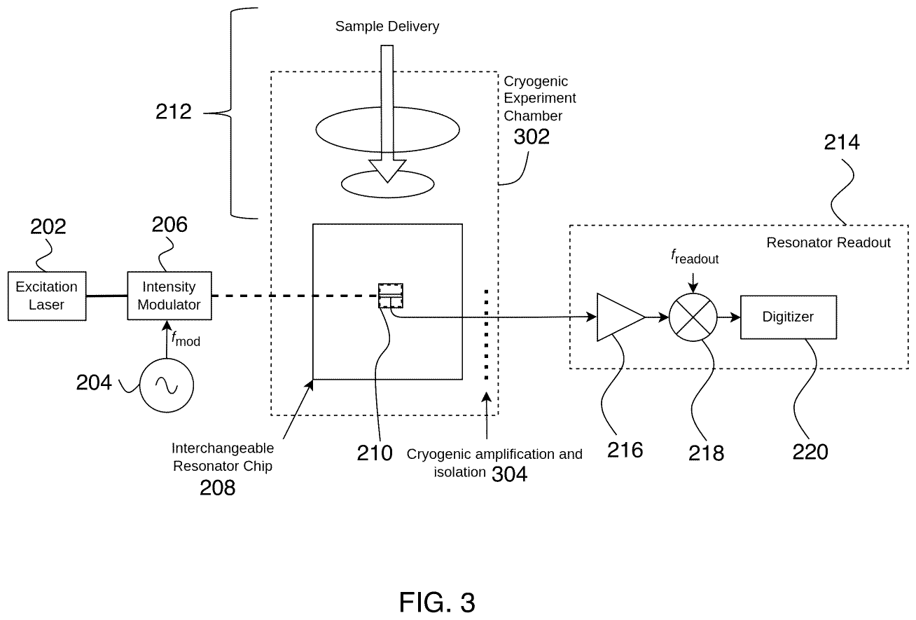

In the example of FIG. 2, mechanical resonator 210 is disposed on an interchangeable resonator chip 208. The sample is delivered to the mechanical resonator via ion optics 212. Here the optical source includes laser 202, intensity modulator 206 and a modulation signal source 204 at frequency f_{mod}. Readout electronics 214 includes an amplifier 216, a mixer 218 having an input at f_{readout} (f_{readout} can be the same as food or different), and a digitizer 220. The example of FIG. 3 is similar to the example of FIG. 2, except that the sample is now inside a cryogenic chamber 302. Here cryogenic amplification and isolation for the signal coming from mechanical resonator 210 is schematically shown as 304.

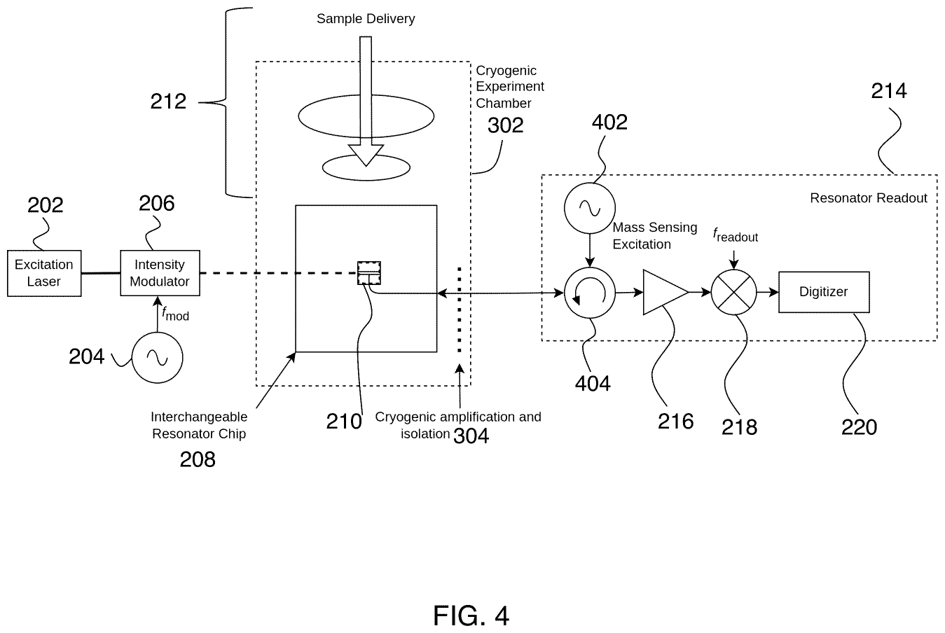

The example of FIG. 4 is similar to the example of FIG. 3, except that a mass detection capability is added. More specifically, readout electronics 214 now includes a mass sensing excitation source 402 and a circulator 404 such that the resonant frequency of mechanical resonator 210 can be measured in addition to the above-described optical absorption measurement. Since the mass of the adsorbed sample shifts the resonant frequency of mechanical resonator 210, the mass of the adsorbed sample can be measured. Measuring both mass and optical absorption of the sample in this way is expected to be useful in various applications, such as sample identification.

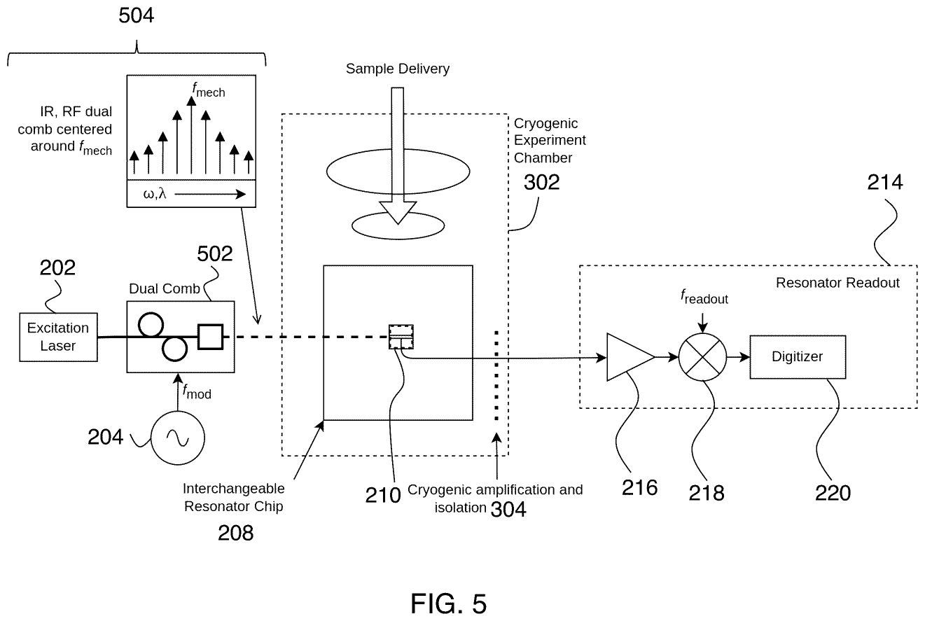

The example of FIG. 5 is similar to the example of FIG. 3, except that the optical source is now a dual-comb source. More specifically, dual comb subsystem 502 provides an optical output at multiple wavelengths, each wavelength (λ) being modulated at a distinct modulation frequency (@), as schematically shown by 504. In this way, absorption measurements at each wavelength in the comb are effectively performed in parallel—the absorption signals from the various wavelengths can be separated from each other in the readout electronics according to their distinct modulation frequencies.

In one example of a dual-comb generator, two optical combs are superposed. These output power at discrete optical frequencies at two spacings Ω and Ω+δ, with some offset frequency between them f_{offset}. Here, these optical frequencies would span some region of the spectroscopic band of interest. Beat tones are generated when these combs interfere. Each pair of comb lines generates its own beat tone. The first beat tone occurs at f_{offset}, the second at f_{offset}+Ω+δ−Ω=f_{offset}+δ, the third at f_{offset}+2δ, the fourth at f_{offset}+38, etc. Other implementations of a dual-comb that generate the same behavior are also possible.

Choosing f_{offset}=f_{mod}≈ω_{mech} centers the highest intensity part of the comb on the mechanical resonance. Then, the remainder of the comb lines would generate RF tones near ω_{mech}. f_{mod} is varied for each dual-comb generator in order to address different mechanical resonance frequencies of different resonators. The other parameters (Ω, δ) could nominally be generated by on-chip optical resonators, or could be set by additional RF sources, depending on the implementation of the comb.

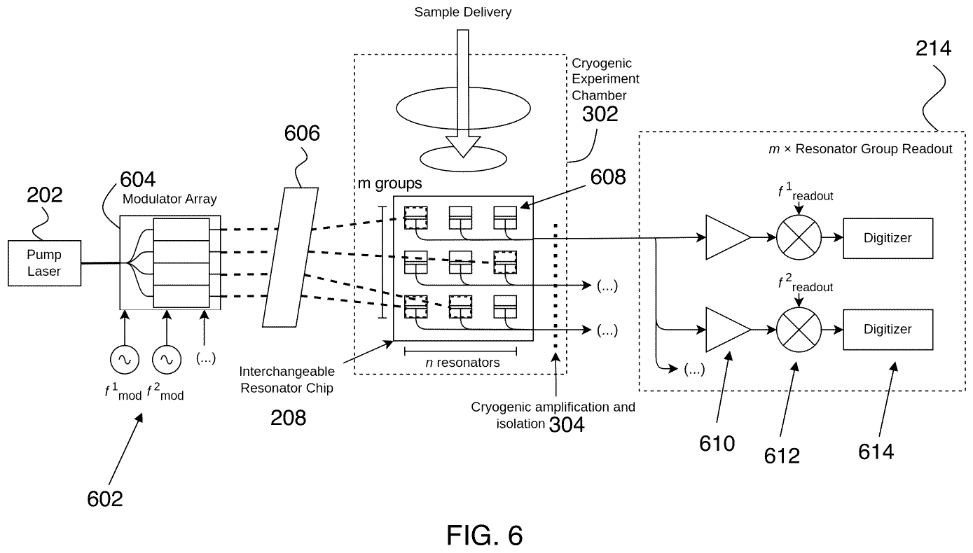

The example of FIG. 6 is similar to the example of FIG. 3, except that now an array of mechanical resonators is used to increase measurement throughput. More specifically, chip 208 now includes array 608 of mechanical resonators (m groups, each group having n resonators in this example). The optical source provides illumination to this array using a modulator array 604 with corresponding input sources 602 (n different input modulation frequencies here) such that all or a subset of the resonators is illuminated with light at a different modulation frequency. Spatial light modulator 606 is used to direct the light to the mechanical resonators as needed. Readout electronics 214 include amplifiers 610, mixers 612 and digitizers 614 used to recover the signals of interest.

In typical cases, each mechanical resonator operates at a different frequency, and these frequencies are separated by much more than a linewidth. In order to drive each resonator in the vicinity of its resonance (e.g., frequency difference <10 Δf), it needs its own drive tone and its own readout tone. In the simplest intensity-modulated case, this readout can be done by mixing with an on-resonance tone and looking at the DC component of the output of the mixer. This mixer can be implemented either in the analog or digital domain. Different measurement schemes may require moving the drive and readout tone away from the mechanical resonance.

In the case where a dual comb is used, the difference in repetition rates between the combs will generate many RF tones around the mechanical resonance. One method of simultaneous readout of these tones is to digitize a sufficiently large bandwidth around the mechanical resonance, then use software processing to separate the signals corresponding to each tone.

The example of FIG. 7 is similar to the example of FIG. 6, except that mass detection as on FIG. 4 and a dual-comb as on FIG. 5 are added. More specifically, nano-electromechanical system (NEMS) resonator array 608 is an m×n array of resonators. A switched RF readout system 214 with n channels monitors the natural frequency of each resonator (for mass sensing) and reads out the optical drive (for absorption spectroscopy).

Comb generator array 702 is a 1D, n-element set of dual-comb generators each as described above. f_{mod} can be independently controlled for each comb generator, but Ω and δ are fixed.

2D Spatial Light Modulator (SLM) 606 maps any element of the comb generator to any element of the NEMS resonator array. This allows for the mapping of n independent optical drives to n arbitrary elements of the array, which are then read out by the RF switch system. It may be possible to use a Digital Micromirror (DMD) system for this. Practice of the invention does not depend critically on the component(s) used to provide this light routing function.

In order to increase the throughput of the system, molecule absorption events can be first detected by changes in the frequencies of the resonators due to mass loading—these frequencies may be monitored in a manner akin to previously reported NEMS mass sensors. After detection of physisorption of a molecule, the SLM can be programmed to illuminate the pixel that has absorbed the molecule with either a swept infrared beam or by a comb containing all of the wavelengths of light simultaneously which is modulated at the new mechanical frequency of the nanomechanical detector. The same resonator can thus be used as both a mass sensor and a force sensor to read out the absorption spectrum photoacoustically.

### Supporting Analysis

### Nanomechanical Resonators

Mechanical devices, particularly those operating at the nanoscale, have displayed enormous potential for sensing, information processing, and communication applications. At the forefront of these technological advancements are phononic crystals-structures that manipulate and control the propagation of mechanical waves through periodic patterns etched in thin films or on the surface of a bulk material. These crystals can confine vibrations to very small mode volumes on the length scale of the wavelength of the acoustic field, making them ideal candidates for sensors with high responsivity to mass and forces. Sensors with high responsivity present numerous applications, from health diagnostics and proteomics to environmental monitoring.

With the rapid progression of nanofabrication techniques, it is now feasible to produce these intricate mechanical devices with high precision and yield on a single chip and to address and manipulate them in an efficient and massively parallelized manner. Furthermore, the blossoming field of quantum technology has paved the way for integrating superconducting circuits with these mechanical devices that can further engineer nonclassical and entangled states, potentially augmenting their sensing capabilities. Moreover, the resultant devices can achieve extraordinarily high-quality factors (Qs) at low temperatures, improving their sensitivity. A high Q factor indicates minimal energy loss and decoherence in the system, enabling extreme sensitivity and enhanced signal transduction. As such, these next-generation mechanical devices promise to herald a new sensing era, transcending traditional systems' limits by drawing on their high responsivity and massive parallelizability.

### Basic System and Sample Assumptions:

### Resonator Geometry, Modes, and Quality Factor

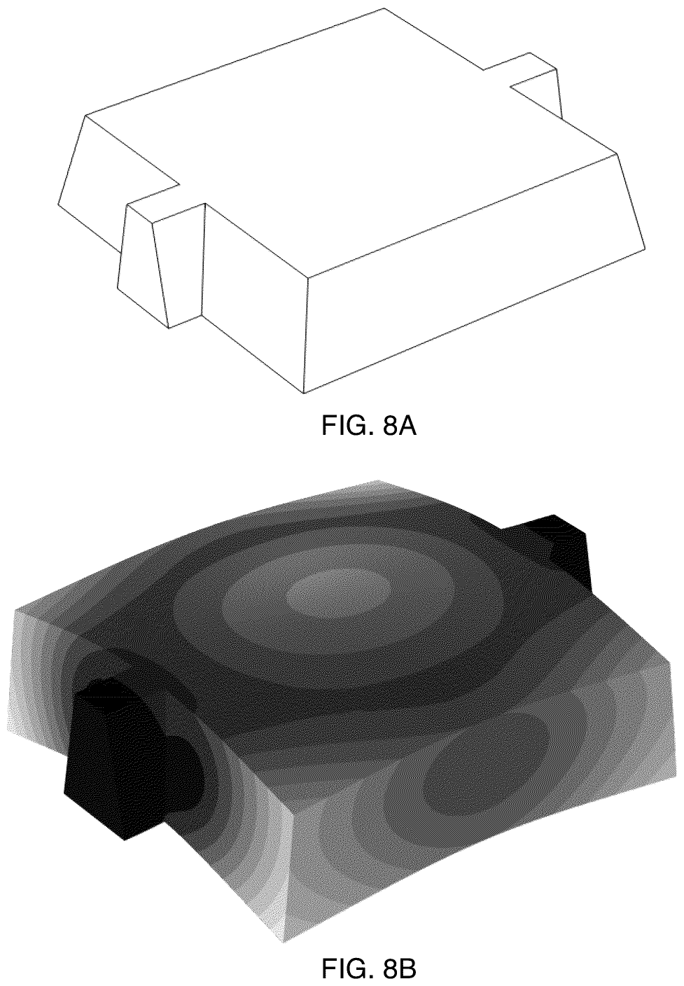

In the ensuing analysis, we assume the resonator to be a LiNbO₃ crystal with a 1 um square footprint and a 200 nm thickness. This resonator is suspended within a 1D phononic crystal with a band gap encompassing the resonator mode. Previous experiments have demonstrated Q=10³ at room temperature and Q=10⁶ at 10 mK for devices with this geometry. A cartoon of the resonator (without the phononic shield) is shown on FIG. 8A.

The photoacoustic signal arises from the interaction of temperature fluctuations in the sample with a specific mode of the resonator. While other resonator modes are discussed for completeness, this analysis generally assumes a drum-like mode at 1.6 GHZ, which is shown on FIG. 8B.

Note however that many other embodiments of the resonator and phononic crystal geometries would be compatible with this technique. One specific example would be the substitution of the 1D phononic crystal with a 2D phononic crystal, which would offer better thermalization in exchange for a larger physical footprint.

Signal Generated from Sample

We assume the target molecule to be a single protein composed of ˜100 amino acids. Extrapolating from liquid-phase IR spectroscopy experiments on single amino acids, we expect a total absorption cross section of σ=10⁻¹⁶ cm² molecule⁻¹. We generally expect illumination on the order of a μW on the device, or an intensity of 10⁶ W/m². This would provide a total absorbed power of 10⁻¹⁴ W.

Note that this system is also sufficiently sensitive to resolve molecules with smaller cross-sections at the same illumination intensity, such as NO₂, which absorbs at 10⁻¹⁸ cm² molecule⁻¹ in the near-UV. However, the rest of this analysis assumes the protein sample.

### Estimation of the Force F₀ Generated by Photoacoustic Transduction

In this section, we first motivate this sensing technique by a back-of-the-envelope 1D calculation of the transduction force generated by a protein, and then validate this calculation with finite element simulations on the full resonator structure.

### 1D Sensor Model

When the top surface of the resonator is periodically heated by the driving laser, there will be induced temperature variation T_{dr}(t) to some depth d_{dr} into the resonator bulk, governed by the driving frequency ω_{mech} and the thermal diffusivity. This temperature variation will lead to expansion and contraction of this d_{dr}, which shifts the center of mass of the entire resonator, thereby applying an effective force F₀ which provides the photoacoustic signal.

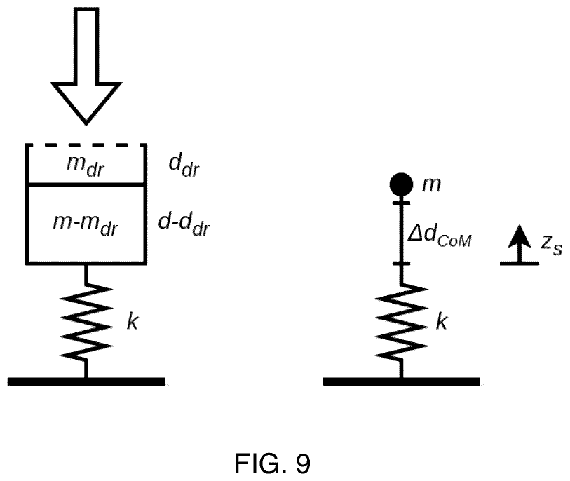

We estimate F₀ for the one-dimensional simple harmonic oscillator (SHO) model of the resonator under several simplifying assumptions. The resonator is taken to be a homogenous one-dimensional mass m of height d, separated into a region d_{dr} (mass m_{dr}), which uniformly oscillates with some temperature variation T_{dr}(t) around its mean temperature, and d−d_{dr} (mass m-mar), which remains at constant temperature (FIG. 9, left). As the top (driving) region oscillates in temperature, it will expand and contract by some Δd_{dr}=T_{dr}(t)d_{dr}α, where α is the coefficient of thermal expansion. The change in the center of mass of the resonator is then:

$$Δ {d}_{CoM} = \frac{{m}_{dr} ( {T}_{dr} ( f ) {d}_{dr} α )}{2 m} .$$

This system is now equivalent to a point mass-on-a-spring where the point-mass to spring separation is modulated by Δd_{CoM} (FIG. 9, right).

We then find the effective force-which is equal in magnitude to the force required generate this oscillation in Δd_{CoM}. The mass oscillates with a displacement Δd_{CoM} at a rate ω_{mech}, therefore:

$${F}_{0}^{accel} = m Δ {d}_{CoM} {ω}_{mech}^{2} cos ( {ω}_{mech} t ) \\ ⇒ 〈 {( {F}_{0}^{accel} )}^{2} 〉 \approx {( \frac{1}{2} m Δ {d}_{CoM} {ω}_{mech}^{2} )}^{2}$$

We take F₀ to be the RMS value

$$\frac{1}{2} m Δ {d}_{CoM} {ω}_{mech}^{2} .$$

Estimating this force due to the molecular drive provides (as stated above) an absorbed power of 10⁻¹⁴ W.

This power generates thermal fluctuations in the resonator, which are numerically simulated with COMSOL. This simulation is done with the full three-dimensional resonator model, and T_{dr} and d_{dr} are extracted from a vertical line cut through the resonator center. This simulation provides T̅_̅{̅d̅r̅}̅(̅t̅)̅≈10⁻¹³ K and d_{dr}=50 nm. Evaluating the above expression for the effective force provides:

$${F}_{0} \approx 1 {0}^{- 18} N$$

Estimation of the force F(t) using Finite Element Analysis (FEA)

We estimate the effective force through FEA on the model resonator. Here, we make similar (albeit weaker) assumptions than as done in the back-of-the-envelope analytical model above.

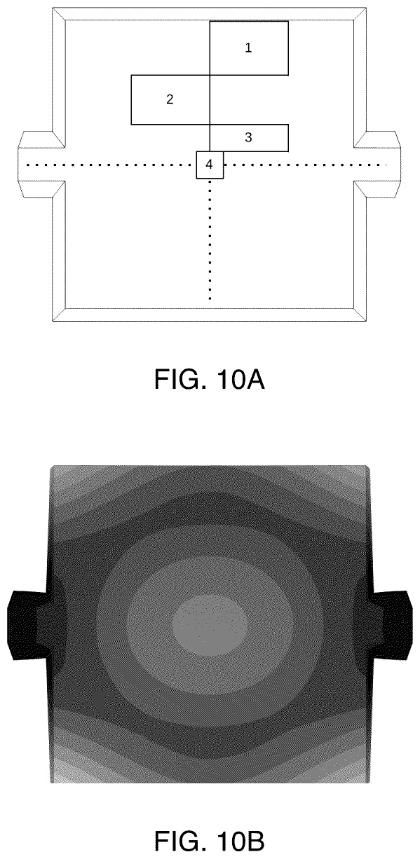

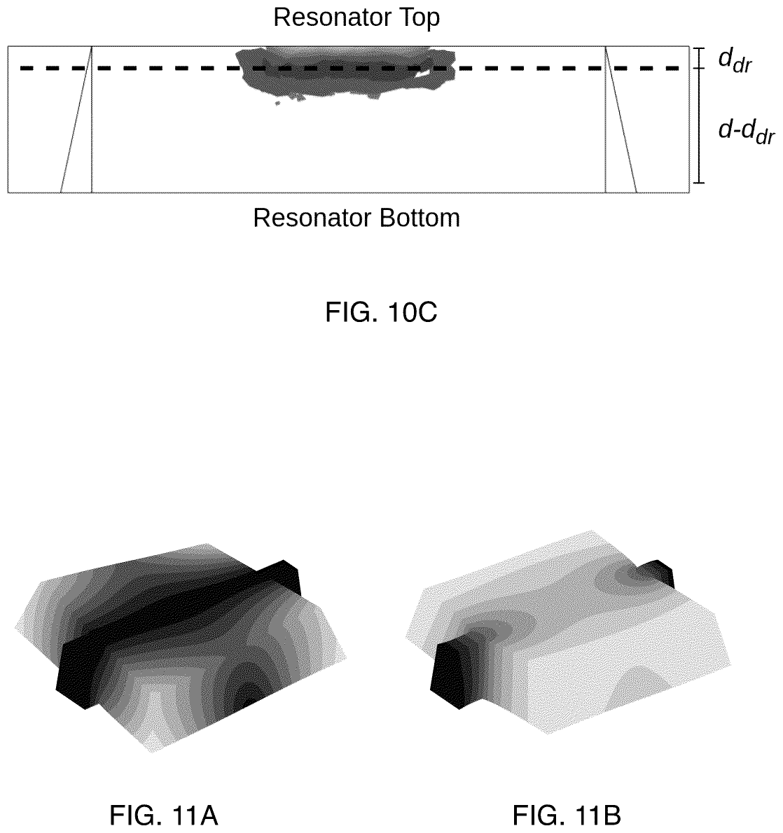

In COMSOL, we define the resonator geometry and illumination conditions. The strength of the mode-sample interaction will be dependent on the relative z-displacement of the mode at the sample position, so several adsorption locations were defined (FIG. 10A), each with different mode displacements. The thermal drive was then uniformly applied over one of these regions. FIG. 10B shows the resonator under test and the drum mode with good z-coupling.

In frequency-domain simulation, we first extract the T_{dr}(t, x, y, z) profile as a function of z, and then manually identify the d_{dr} below which little thermal variation occurs. As d_{dr} is small compared to the resonator thickness, the mode will mainly exist in the lower (d−d_{dr}) portion of the resonator that remains at a constant temperature. This is shown on FIG. 10C, which illustrates thermal isosurfaces due to a drive in the center of the resonator's top surface.

The thermal fluctuations will produce a strain field at d_{dr} which couples to the resonator mode. As the z-displacement of the mode is approximately constant from z=0 to z=d_{dr}, the z-component of the simulated strain field at the z=d_{dr} plane, driven by temperature fluctuations in the region of the resonator above z=Z_{dr}, is a good approximation of the thermal drive on the mode. Note that no components of the strain field aside from zz significantly contribute to the mode coupling, so they are ignored in this analysis.

The effective force can then be found by integrated the stress induced by this strain against the normalized mode z-displacement, using the following expression, where σ is the stress-strain tensor, S_{zz}(\vec{a}=(x, y, z=d_{dr})) is the zz-component of the strain, and 1/(Z_{mode}^{max}×A) normalizes the z-displacement of the mode:

$${F}_{0} = \frac{{σ}_{zz}}{{Z}_{mode}^{max} \times A} {\int }_{A} d \vec{a} ( {Z}_{mode} ( \vec{a} ) {S}_{zz} ( \vec{a} ) ) .$$

This is evaluated for several resonator modes and several adsorption regions, and the results obtained are similar to the first principles (1D) calculations above. Note that the 1D calculation assumes perfect coupling and overestimates the modal mass, leading to the observed differences from the FEA calculations.

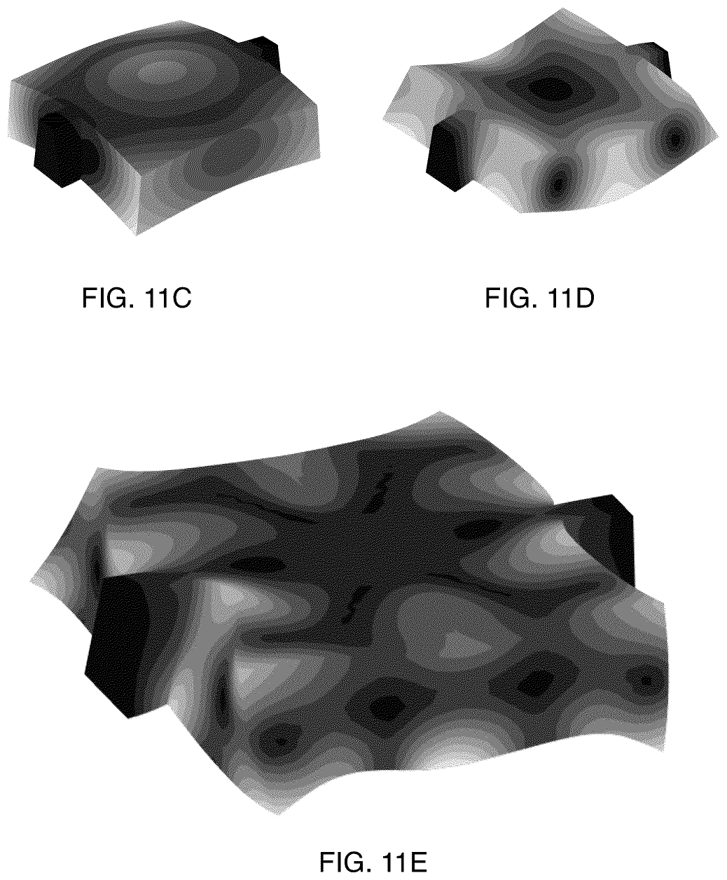

Furthermore, there are two important assumptions in this analysis that will not generally hold:
1. This calculation is effectively a coherent average of effective force over an adsorption region. This may lead to cancellations and therefore artificial reductions in the calculated effective force, as the z-displacement of the mode may be both positive and negative within a region. These adsorption regions are made artificially large to aid in simulation: a protein is nanometers in size, and so is unlikely to span a region with both positive and negative responses. This analysis will therefore generally underestimate the true effective force for single-molecule spectroscopy. Spatial averaging to help distinguish single molecule absorption from widespread surface absorption (which could be a parasitic from a surface contaminant) can be enhanced by using a higher order mode as shown in the example of FIG. 11 E.
2. The physical processes driving photoacoustic transduction are temperature dependent, and will differ between room temperature and low temperatures. In the low temperature case, the phonon coherence time and anharmonicity in the molecule play an essential role. We would still expect large forces to be generated, but detailed calculations and experimental backing are needed for understand and optimize low temperature operation.

### Calculation of the Force for Several Resonator Modes

To clarify the importance of the mode shape on the responsivity, F₀ was calculated for several modes of the resonator. We introduce the ZZ modal participation factor (the translational participation of the mode along z) as a heuristic for the responsivity of the mode. In general, F₀ is expected to depend on the overall ZZ participation factor: a mode with more mass moving along z will respond more strongly to strain along z, but in the small-absorber case, the specific z-displacement of the mode within the adsorption region becomes significant.

We evaluate the participation factor and F₀ for four modes, including the drum mode discussed earlier, two modes with low ZZ participation factors, and one mode with a high ZZ participation factor but an unsuitable mode shape due to low displacement in the adsorption region. For these calculations, the adsorption region is in the center of the resonator, and the single-protein absorption power was averaged uniformly over the adsorption region.

| | | | ZZ | |
|---|---|---|---|---|
| | | Frequency | Participation | |
| Mode | Shape | (Hz) | Factor | F_0 (N) |
| Low-Z 1 | FIG. 11A | 1.0 × 10⁹ | 1.7 × 10⁻¹² | 6.6 × 10⁻²¹ |
| Low-Z 2 | FIG. 11B | 1.1 × 10⁹ | 3.7 × 10⁻¹² | 1.3 × 10⁻²⁰ |
| Drum | FIG. 11C | 1.6 × 10⁹ | 7.6 × 10⁻¹⁰ | 2.7 × 10⁻¹⁷ |
| High-Z | FIG. 11D | 2.0 × 10⁹ | 7.2 × 10⁻⁹ | 2.6 × 10⁻¹⁸ |

In this example, the drum mode, with high z-translation in the adsorption region, offers the highest responsivity. For other sensing schemes—for example, if a large number of molecules were to be adsorbed-other modes may be preferable.

### Calculation of the Force for Several Adsorption Locations

Within a single mode, the z-translation varies spatially. This will change the responsivity as a function of adsorption location. F₀ was calculated for four adsorption locations (as shown on FIG. 10A), each sampling from a different z-displacement region of the mode.

| Driving Region | Effective Force (N) |
|---|---|
| 1 | 1.5 × 10⁻¹⁸ |
| 2 | 1.7 × 10⁻¹⁷ |
| 3 | 2.5 × 10⁻¹⁷ |
| 4 | 2.7 × 10⁻¹⁷ |

There is about an order-of-magnitude variance in responsivity over the four regions. The center region (4) has the highest z-translation and therefore the highest responsivity, as one would expect for the drum mode used in the calculations of this example.

### Cross-Talk Due to Bulk Absorption

Internal experiments have demonstrated a 10 dB m⁻¹ loss in LiNbO₃ integrated photonics. The nanomechanical resonators discussed here will exhibit the same loss. We further assume that this loss is homogenous within the resonator. Given this loss, the dimensions of the resonator, and a driving intensity of 106 Wm⁻², we expect an average dissipation of 2×10⁶ Wm⁻³ in the resonator bulk.

This bulk absorption will couple to the resonator mode and create some effective force, which can be estimated through the same technique as above, providing F₀^{crosstalk}=4×10⁻²⁰ N. This is substantially smaller than the signal due to molecular driving and so can be neglected. In general, it is preferred that the sample absorption couples more efficiently to the resonator mode than the bulk absorption, and the preceding exemplary calculations provide examples of when this condition is met (drum and high-Z modes) and isn't met (low-Z modes).

Furthermore, the DC component of this absorption will heat the resonator, adding to thermal population. This effect is again negligible, as in simulation the steady-state heating is less than 10⁻⁴ K, much less than the temperature corresponding to a single photon.

### Noise Estimation

The noise in the system will be dominated by the thermal population in the resonator as well as shot noise in the readout. Thermal noise in the readout is not considered due to the availability of high-gain low-noise cryogenic amplifiers. The signal to noise can be evaluated by treating the system as an oscillator weakly coupled to a thermal bath and to an output channel.

The SNR is then evaluated for temperatures spanning from 0.01 K to room temperature. In the high-temperature limit, the system is dominated by thermal population, and the approximate SNR is found to be, where t is the integration time:

$$SNR \approx {F}_{0} \sqrt{\frac{Q τ}{2 m {ω}_{mech} {k}_{B} T}}$$

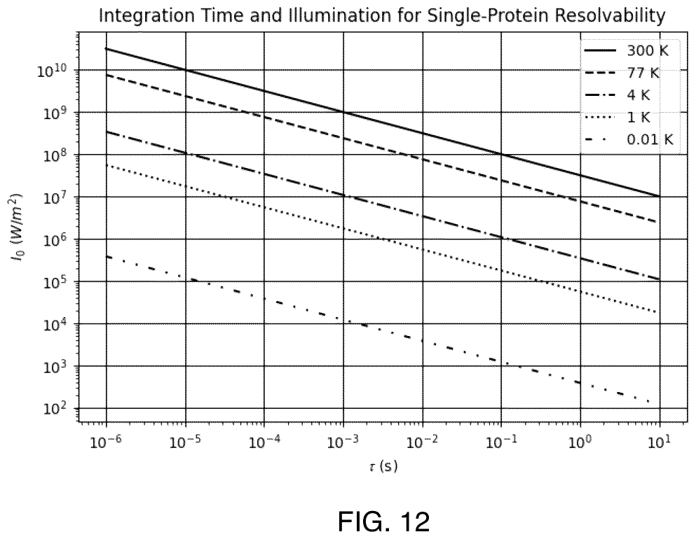

At low temperatures, shot noise becomes significant, and so the output coupling rate is chosen to maximize SNR. For each integration time we solve for the incident intensity to find SNR=1. Note that the Q is taken to be temperature dependent and extracted from prior experiments on these resonators. FIG. 12 shows the results of these noise calculations.

### Variations

2D phononic crystal resonators.
Other mechanical resonant structures, such as drum membrane resonators, beam resonators, surface acoustic wave resonators and disc resonators.
electromechanical as opposed to piezoelectric transduction and detection of motion.
optical read-out as opposed to microwave frequency read-out via piezoelectric/electromechanical transduction
Other piezoelectric materials beyond lithium niobate, such as lithium tantalate, GaP, AlN, GaAs, GaN, AlScN, and so on.

1. Apparatus for absorption spectroscopy, the apparatus comprising:
at least one mechanical resonator including a surface configured to adsorb a sample;
an optical source, wherein the optical source is intensity modulated at a modulation frequency f_{mod}, and wherein the light source is configured to illuminate the surface with modulated source radiation;
a detector of mechanical motion of the at least one mechanical resonator;
wherein absorption of the modulated source radiation by the sample adsorbed on the surface causes mechanical oscillation of the at least one mechanical resonator at frequency f_{mod};
wherein the detector is configured to sense the mechanical oscillation of the at least one mechanical resonator and provide an output signal;
whereby the output signal is a measure of optical absorption by the sample.

2. The apparatus of claim 1, wherein the at least one mechanical resonator has a mode having resonance frequency fᵣₑₛ, wherein a full-width half-maximum line width of the mode is Δf, and wherein |fᵣₑₛ−f_{mod}|≤10Δf.

3. The apparatus of claim 2, wherein the mode is a higher-order mode having two or more antinodes on the surface.

4. The apparatus of claim 2, wherein sample absorption of the modulated source radiation couples more efficiently to the mode having resonance frequency fᵣₑₛ than bulk absorption of the modulated source radiation.

5. The apparatus of claim 1, wherein the sample is a single molecule.

6. The apparatus of claim 1, wherein the optical source is tunable, whereby an absorption spectrum of the sample can be obtained by scanning an output wavelength of the optical source.

7. The apparatus of claim 1, wherein the optical source is a dual-comb source configured to provide two or more emission wavelengths, each emission wavelength having a distinct intensity modulation frequency, whereby an absorption spectrum of the sample can be obtained at all emission wavelengths simultaneously.

8. The apparatus of claim 1, further comprising a cryogenic chamber, wherein the at least one mechanical resonator is disposed within the cryogenic chamber, whereby a signal to noise ratio of optical absorption measurement is improved.

9. The apparatus of claim 8, wherein the at least one mechanical resonator has a squeezed vacuum state to improve sensitivity.

10. The apparatus of claim 1, further comprising a sensor of adsorbed sample mass.

11. The apparatus of claim 10, wherein the sensor of adsorbed sample mass is configured to sense a change in a resonant frequency of the at least one mechanical resonator due to the adsorbed sample mass.

12. The apparatus of claim 1,
wherein the at least one mechanical resonator comprises two or more mechanical resonators;
wherein the optical source comprises two or more dual-comb sources each configured to provide two or more emission wavelengths, each emission wavelength having a distinct intensity modulation frequency;
further comprising optics configured to map optical emission from the two or more dual-comb sources to the two or more mechanical resonators;
whereby improved sensing throughput is provided.

13. The apparatus of claim 1, wherein the at least one mechanical resonator is piezoelectric, whereby the detector of mechanical motion of the at least one mechanical resonator includes electrodes disposed to sense a piezoelectric voltage of the at least one mechanical resonator.

14. The apparatus of claim 13, wherein the electrodes are substantially not illuminated by the optical source.
